(19) United States
(12) Patent Application Publication
(10) Pub. No.: US 2014/0321127 A1
(43) Pub. Date: Oct. 30, 2014

(54) LIGHT EMITTING DIODE MODULE FOR DIRECT-TYPE BACKLIGHT MODULE

(71) Applicant: ADVANCED OPTOELECTRONIC TECHNOLOGY, INC., Hsinchu Hsien (TW)

(72) Inventors: CHAO-HSIUNG CHANG, Hukou (TW); CHE-HSANG HUANG, Hukou (TW); HOU-TE LIN, Hukou (TW); PIN-CHUAN CHEN, Hukou (TW)

(73) Assignee: ADVANCED OPTOELECTRONIC TECHNOLOGY, INC., Hsinchu Hsien (TW)

(21) Appl. No.: 14/086,978

(22) Filed: Nov. 22, 2013

(30) Foreign Application Priority Data
Apr. 29, 2013 (CN) 2013101550697

(51) Int. Cl. F21V 13/04; F21K 99/00

(52) U.S. Cl. CPC F21V 13/04; F21K 9/50
USPC 362/308

(57) ABSTRACT

An LED module for use in a direct-type backlight module includes a printed circuit board, an LED arrange on the printed circuit board and electrically connected to the printed circuit board, and a lens covering the LED and fixed on the printed circuit board. A reflective layer is arranged on the printed circuit board. A semi-transparent surface is recessed and tampered from a top of a column-shaped protrusion at a center of the lens towards the LED. Part of light beams emitted from a center of the LED is refracted and diffused by the semi-transparent surface to an outside, and another part of the light beams emitted from a center of the LED is reflected by the semi-transparent surface to the reflective layer, and then reflected by the reflective layer to the outside.

### BACKGROUND

1. Technical Field

The disclosure relates to light source modules, and particularly to a light emitting diode (LED) module with a larger radiation angle, wherein the LED module is used as a light source for a direct-type backlight module.

2. Discussion of Related Art

Light emitting diodes' (LEDs) many advantages, such as high luminosity, low operational voltage, low power consumption, compatibility with integrated circuits, faster switching, long term reliability, and environmental friendliness have promoted their wide use as a lighting source.

However, the conventional LED cannot have a wide illumination area even if it is used with a diverging lens. The light having a large incidence angle on the light emerging face of the diverging lens may be totally reflected backwardly into the diverging lens. Thus, the radiation angle of the light emitted out of the diverging lens is limited, generally less than 120 degrees. In other words, the light intensity dramatically decreases when the radiation angle exceeds 120 degrees. The limited radiation angle of the conventional LED limits its use as a light source for a direct-type backlight module for illuminating a planar display device such as a liquid crystal display (LCD) or a sign box.

Therefore, what is needed is an LED module for a direct-type backlight module which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present LED module. Moreover, in the drawing, like reference numerals designate corresponding parts throughout the whole view.

FIG. 1 is a cross-sectional view of an LED module according to an exemplary embodiment.

FIG. 2 is a top plan view of the LED module of FIG. 1.

FIG. 3 is a top plan view of the LED module of FIG. 1, with lenses of the LED module being removed for clarity.

### DETAILED DESCRIPTION OF EMBODIMENTS

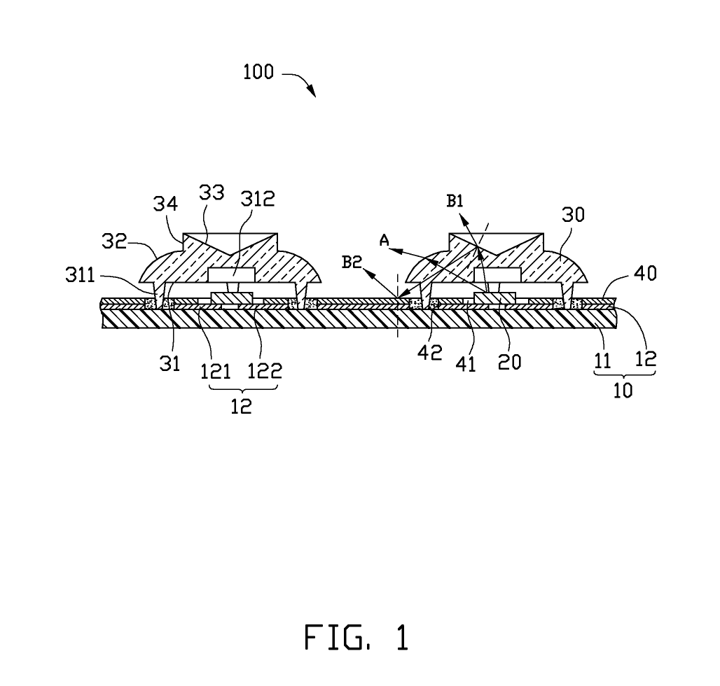

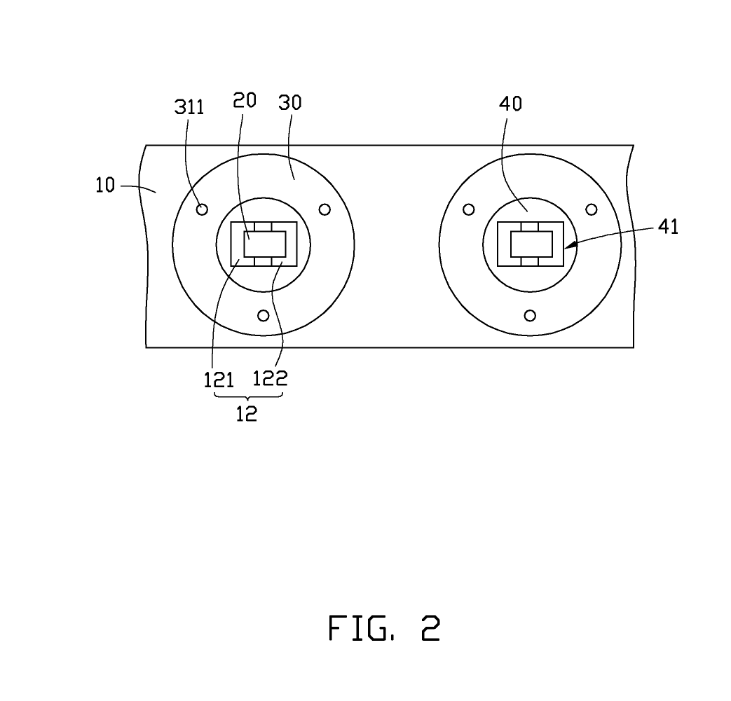

Referring to FIGS. 1 and 2, an LED module 100 in accordance with an exemplary embodiment of the present disclosure is shown. The LED module 100 is used for constructing a direct-type backlight module for illuminating a planar display device, such as a liquid crystal display (LCD) or a sign box. The backlight module includes at least a light diffusion plate located over the LED module 100. The LED module 100 includes a printed circuit board 10, a plurality of LEDs 20 arranged on the printed circuit board 10 and a plurality of lenses 30 respectively covering the LEDs 20.

The printed circuit board 10 is used for supporting the LEDs 20 and the lenses 30. The LEDs 20 are electrically connected to an external power source via the printed circuit board 10. The printed circuit board 10 is substantially rectangle, and includes a base 11 and a circuit layer 12 formed on the base 11. The circuit layer 12 is electrically connected to the LEDs 20, and includes a plurality of first circuits 121 and a plurality of second circuits 122 spaced from the first circuits 121. Each LED 20 is connected to a first circuit 121 and an adjacent second circuit 122.

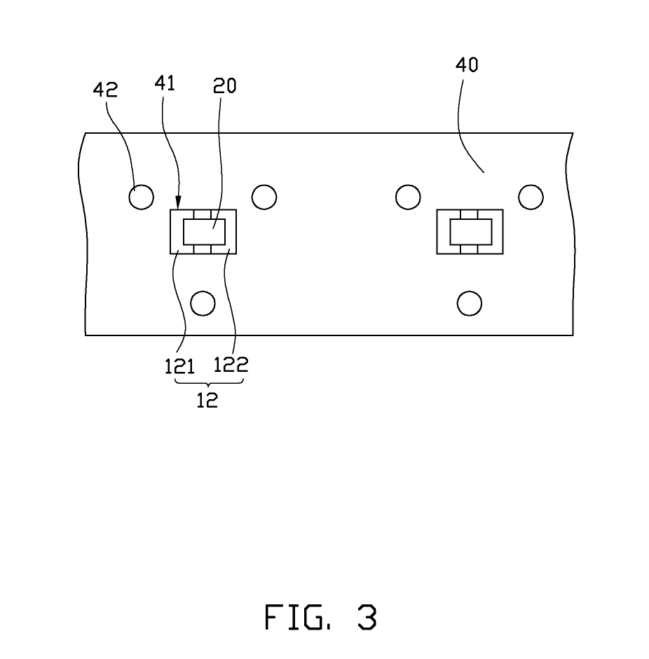

Referring to the FIG. 3, a reflective layer 40 is arranged on the circuit layer 12 of the printed circuit board 10. The reflective layer 40 is used for reflecting light emitted from the LEDs 20. The reflective layer 40 defines a plurality of openings 41 each for exposing a corresponding first circuit 121 and a corresponding second circuit 122. Each LED 20 is arranged on one of the openings 41 and electrically connected to the corresponding first circuit 121 and the corresponding second circuit 122. A plurality of holes 42 extend through the circuit layer 12 and the reflective layer 40 and reach to a top surface of the base 11 of the printed circuit board 10. In the present embodiment, three holes 42 evenly surround each LED 20. In an alternative embodiment, there can be two, four or more than four holes 42 surrounding each LED 20.

Each lens 30 covers an LED 20. Light emitted from the LED 20 enters a corresponding lens 30. Each lens 30 includes a bottom surface 31, a light output surface 32 connected to the bottom surface 31, and a semi-transparent surface 33 opposite to the bottom surface 31 and surrounded by the light output surface 32. In the present embodiment, a central axis of each lens 30 is coaxial to that of a corresponding LED 20. The semi-transparent surface 33 is inclined relative to the printed circuit board 10 and the bottom surface 31 of the lens 30.

The bottom surface 31 of each lens 30 is opposite to and above the corresponding LED 20. The bottom surface 31 acts as a light input surface of the lens 30, and light emitted from each LED 20 enters the corresponding lens 30 via the bottom surface 31. A concave portion 312 is column and depressed from a center of the bottom surface 311 towards the semi-transparent surface 33 of the lens 30. The concave portion 312 is directly over the corresponding LED 20. A plurality of supporting poles 311 extend downwardly from the bottom surface 31 of the lens 30. In the present embodiment, each lens 30 includes three supporting poles 311, and each supporting pole 311 is arranged in one of the holes 42 to fix the lens 30 on the printed circuit board 10. In the present embodiment, a height of the supporting pole 311 is larger than that of the corresponding hole 42; therefore, a space is defined between the bottom surface 31 of the lens 30 and a top surface of the corresponding LED 20. Most light emitted from the LED 20 enters into the corresponding lens 30 via the concave portion 312, and remaining light emitted from the LED 20 enters the corresponding lens 30 via the bottom surface 31. The holes 42 can be filled with liquid adhesive firstly, and then the supporting poles 311 of the lens 30 are inserted into the holes 42. After the liquid adhesive is solidified, the supporting poles 311 are fixed on the printed circuit board 10. In an alternative embodiment, the LED 20 can be received in a corresponding concave portion 312, and the whole light emitted from the LED 20 enters the corresponding lens 30 via a surface of the corresponding lens 30 defining the concave portion 312, without via the bottom surface 31.

The light output surface 32 of the lens 30 is a convex surface, and extends inwardly and upwardly from a periphery edge of the bottom surface 31. In the present embodiment, the light output surface 32 is an arced-shaped, curved surface. A circular column-shaped protrusion 34 protrudes upwardly from an inner edge of the light output surface 32 and located at a center of the lens 30.

The semi-transparent surface 33 is depressed from a center of the protrusion 34 towards the concave portion 312 of the lens 30. The semi-transparent surface 33 is slant downwardly from a top, outer edge of the protrusion 34 toward the concave portion 312, and a lowest point of the semi-transparent surface 33 is above the concave portion 312. In other words, the semi-transparent surface 33 has an inner diameter gradually decreasing in a direction towards the LED 20. In the present embodiment, the semi-transparent surface 33 has an inverted conical shape and is directly over the corresponding LED 20, and an optical axis of the semi-transparent surface 33 is coaxial to that of the lens 30 and the corresponding LED 20. In an alternative embodiment, the semi-transparent surface 33 can have a shape of an inverted pyramid. The lowest point of the semi-transparent surface 33 is located at the optical axis of the lens 30. A ratio of the reflection coefficient relative to the transmission coefficient of the semi-transparent surface 33 is in a range from 1:3 to 3:1; therefore, 25 percent to 75 percent of light incident on the semi-transparent surface 33 penetrates through the semi-transparent surface 33, and the remaining portion of the light is reflected by the semi-transparent surface 33 towards the printed circuit board 10. In the present embodiment, 50 percent of the light incident on the semi-transparent surface 33 penetrates through the semi-transparent surface 33. The other 50 percent of the light incident on the semi-transparent surface 33 is reflected by the semi-transparent surface 33 to the printed circuit board 10. The semi-transparent surface 33 can has a reflective layer having a plurality of concentric annular reflecting strips periodically arranged thereon.

Light beams emitted from a center of the LED 20 with a small light radiation angle enter into the corresponding lens 30 via the concave portion 312, wherein a part of the light beams such as light beams B2 shown in FIG. 1 is reflected by the semi-transparent surface 33 to the reflective layer 40, and then reflected by the reflective layer 40 to an upper side of the LED module 100 wherein a light diffusion plate (not shown) is located; the other part of the light beams such as light beams B1 shown in FIG. 1 is refracted and diffused by the semi-transparent surface 33 to the upper side of the LED module 100. Light beams emitted from the center of the LED 20 with large light radiation angles such as light beams A shown in FIG. 1 enter the corresponding lens 30 via the bottom surface 31 and are refracted and diffused by the light output surface 32 or a side surface of the protrusion 34 to the upper side of the LED module 100. Therefore, light beams emitted from the LED 20 are scattered, and the radiation angle of the LED module 100 is increased. When the LED module 100 acts as the light source of an illumination device, light beams emitted from the LEDs 20 are diverged by the lenses 30, whereby the light source can illuminate a wide area. Therefore, the number of the LEDs 20 for constructing the LED module 100 can be reduced, and the cost is down.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A light emitting diode (LED) module comprising:
a printed circuit board having a reflective layer arranged on the printed circuit board;
an LED arranged on the printed circuit board and electrically connected to the printed circuit board; and
a lens covering the LED and fixed on the printed circuit board, the lens being located over the reflective layer and comprising a column-shaped protrusion at a center of a top thereof, a semi-transparent surface recessed and tapered from a top of the protrusion of the lens toward the LED, the semi-transparent surface being inclined relative to the printed circuit board;
wherein a part of light emitted from the LED is refracted by the semi-transparent surface to an outside, and another part of the light emitted from the LED is reflected by the semi-transparent surface to the reflective layer, and then reflected by the reflective layer to the outside.

2. The light emitting diode module of claim 1, wherein the lens further comprises a convex light output surface surrounding the column-shaped protrusion.

3. The light emitting diode module of claim 2, wherein the protrusion has a shape of a circular column, protruding upwardly from an inner edge of the light output surface and located at a center of the lens, and the semi-transparent surface is depressed downwardly from an outer, top edge of the protrusion toward the LED.

4. The light emitting diode module of claim 3, wherein the lens further comprises a bottom surface, the light output surface extending inwardly and upwardly from a periphery edge of the bottom surface to the protrusion.

5. The light emitting diode module of claim 4, wherein a plurality of supporting poles extend downwardly from the bottom surface of the lens, and the supporting poles extend through the reflective layer and are arranged on the printed circuit board to fix the lens on the printed circuit board.

6. The light emitting diode module of claim 4, wherein a concave portion is depressed from a center of the bottom surface towards the protrusion, and the concave portion is directly over the LED.

7. The light emitting diode module of claim 1, wherein the semi-transparent surface has an inverted conical shape.

8. The light emitting diode module of claim 1, wherein the semi-transparent surface has a shape of an inverted pyramid.

9. The light emitting diode module of claim 1, wherein the printed circuit board comprises a base and a circuit layer formed on the base, the reflective layer being arranged on the circuit layer, the circuit layer comprising at least a first circuit and at least a second circuit spaced from the at least a first circuit.

10. The light emitting diode module of claim 9, wherein the reflective layer defines at least an opening for exposing parts of the at least a first circuit and the at least a second circuit, the LED being arranged in the at least an opening and electrically connected to the exposed parts of the at least a first circuit and the at least a second circuit.

11. The light emitting diode module of claim 1, wherein a central axis of the semi-transparent surface is coaxial to that of the lens and the LED.

12. A light emitting diode (LED) module for use in a direct-type backlight module comprising:
a printed circuit board;
a reflective layer arranged on the printed circuit board;
a plurality of LEDs arranged on the printed circuit board and electrically connected to the printed circuit board; and
a plurality of lenses each covering a corresponding LED and fixed on the printed circuit board, each lens comprising a bottom surface, a convex light output surface extending inwardly and upwardly from a periphery edge of the bottom surface, and a semi-transparent surface recessed and tapered from a center of a top of the lens toward the corresponding LED and being inclined relative to the bottom surface;
wherein a part of light emitted from each LED with a small light radiation angle is refracted by the semi-transparent surface of a corresponding lens to an outside, and another part of the light emitted from the each LED with the small light radiation angle is reflected first by the semi-transparent surface of the corresponding lens and then by the reflective layer to the outside, and light emitted from the each LED with a large light radiation angle is refracted by the light output surface of the corresponding lens to the outside.

13. The light emitting diode module of claim 12, wherein each lens comprises a column-shaped protrusion protruding upwardly from an inner edge of the light output surface and located at a center of each lens, and the semi-transparent surface is depressed downwardly from the protrusion towards a corresponding LED.

14. The light emitting diode module of claim 12, wherein the semi-transparent surface has one of following shapes: inverted cone and inverted pyramid.

15. The light emitting diode module of claim 12, wherein a plurality of supporting poles extend downwardly from the bottom surface of each lens, and the supporting poles extend through the reflective layer and arranged on the printed circuit board to fix each lens on the printed circuit board.

16. The light emitting diode module of claim 12, wherein a concave portion is depressed from a center of the bottom surface towards the semi-transparent surface, and the concave portion is directly over a corresponding LED.

17. The light emitting diode module of claim 16, wherein the bottom surface of each lens is spaced a distance from a corresponding LED.

18. The light emitting diode module of claim 17, wherein the semi-transparent surface is recessed and tapered downwardly from a top surface of a column-shaped protrusion extending upwardly from the center of top of the each lens.
